(19) United States
(12) Patent Application Publication
(10) Pub. No.: US 2010/0277825 A1
(43) Pub. Date: Nov. 4, 2010

(54) HARD DISK ACCESS METHOD

(75) Inventor: Ming-Hung CHIEN, TAIPEI CITY (TW)

Correspondence Address: BRIAN M. MCINNIS, 12th Floor, Ruttonjee House, 11 Duddell Street, Hong Kong, HK

(73) Assignee: INVENTEC CORPORATION, TAIPEI CITY (TW)

(21) Appl. No.: 12/495,810

(22) Filed: Jul. 1, 2009

(30) Foreign Application Priority Data
Apr. 30, 2009 (TW) 98114461

(51) Int. Cl. G11B 15/18

(52) U.S. Cl. 360/71

(57) ABSTRACT

A hard disk access method is disclosed. The hard disk access method includes the following steps. A port mapping table is established in the execution of a startup process. An access instruction for accessing a target hard disk is received. A target slot of a target back plate, which the target hard disk is plugged in, is obtained according to a target-hard-disk-identification number of the target hard disk. According to the target-hard-disk-identification number of the target hard disk, the port mapping table is inquired to obtain a target port, which the target back plate is connected with. The target hard disk plugged in the target slot of the target back plate is accessed through the target port.

### RELATED APPLICATIONS

This application claims priority to Taiwan Application Serial Number 98114461, filed Apr. 30, 2009, which is herein incorporated by reference.

### FIELD OF THE INVENTION

The present invention relates to a hard disk access method, and more particularly to a hard disk access method for hard disk expansion.

### BACKGROUND OF THE INVENTION

As the computer is becoming popular, the amount of data stored in the computer by people is growing larger. Therefore, computer companies have to continually develop storage mediums with greater capacity. Among them, the hard disk is most widely applied, which is characterized by high capacity and low cost.

In addition, in order to further increase the capacity of the computer, a back plate is developed. The back plate includes a plurality of slots, which hard disks can be plugged in, and the back plate is connected to a port of an expander to communicate data with the computer.

In order to be plugged with many hard disks simultaneously, the back; plate has a larger volume, in a computer host with limited capacity, the back plate and the hard disks plugged therein are often moved in order to increase or modify peripheral hardware devices. After the back plate is moved, its port plugged in an expander also needs to be moved. However, the computer cannot identify the hard disk plugged in the back plate while the port, which the back plate is connected with is changed. Thus, the hard disk plugged in the back plate needs to be set anew. Furthermore, before the hard disk is set anew, the data stored in the hard disk cannot be accessed. Therefore, it is inconvenient for the user.

### SUMMARY OF THE INVENTION

Therefore, one objective of the present invention is to provide a hard disk access method, in which a port mapping table is dynamically established during a startup process. Thus, before the access of the hard disk, a port, connected to the hard disk can be obtained by inquiring the port mapping table, and the hard disk can be accessed through the port.

According to an embodiment of the present invention, a hard disk access method is provided. The hard disk access method includes the following steps. A port mapping table is established in the execution of a startup process. When an access instruction for accessing a target hard disk is received, a target slot of a target back plate, which the target hard disk is plugged in, is obtained according to a target-hard-disk-identification number of the target hard disk. According to the target-hard-disk-identification number of the target hard disk, the port mapping table is inquired to obtain a target port, which the target back plate is connected with. Then, the target hard disk plugged in the target slot of the target back plate is accessed through the target port.

### BRIEF DESCRIPTION OF THE DRAWINGS

The foregoing aspects, features, advantages and embodiments of this invention are more readily appreciated as the same become better understood by reference to the following detailed description, when taken in conjunction with the accompanying drawings, wherein:

FIG. 1 is a flowchart illustrating a hard disk access method 100 in accordance with an embodiment of the present invention;

FIG. 2 is a schematic diagram showing a hard disk expansion system 200 using a hard disk access method 100; and

FIG. 3 illustrates a port mapping table 300 of the hard disk expansion system 200 in FIG. 2.

### DETAILED DESCRIPTION OF THE PREFERRED EMBODIMENT

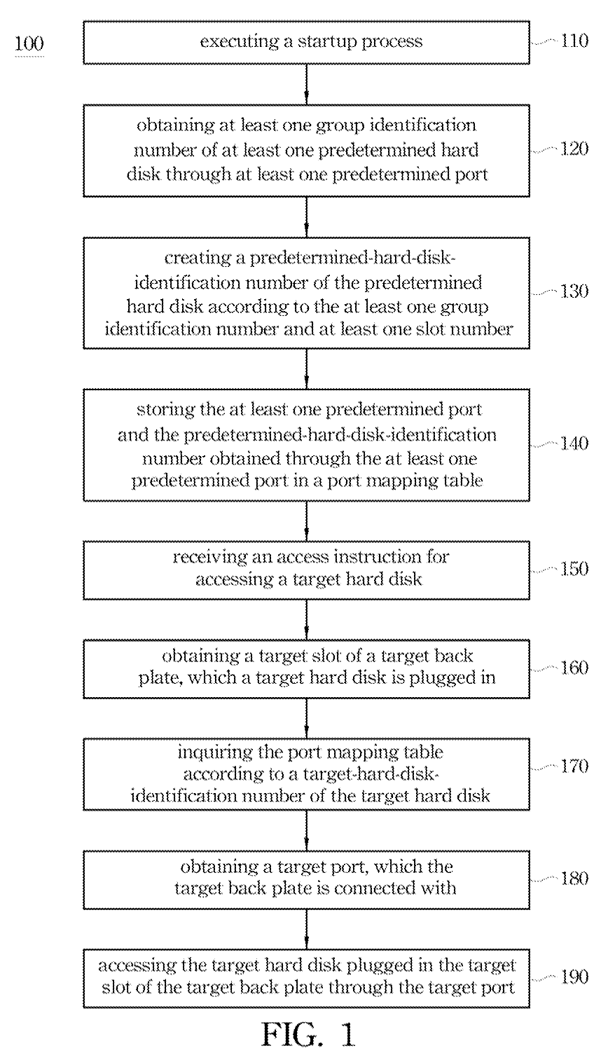

Referring to FIG. 1, FIG. 1 is a flow chart of a hard disk access method 100 in accordance with an embodiment of the present invention. In the execution of each startup process, a port mapping table is dynamically established in the hard disk access method 100. Thus, before the access of a hard disk, a port connected to the hard disk can be obtained by inquiring the port mapping table, and the hard disk can be accessed through the port. The hard disk access method 100 includes the following steps.

In the execution of a startup process (step 110), at least one group identification number of at least one predetermined hard disk is obtained (step 120) through at least one predetermined port. The predetermined hard disk is plugged in a predetermined slot of a predetermined back plate, and the predetermined hard disk can use a back plate identification number of the predetermined back plate as the group identification number. The back plate identification number of the predetermined back plate can be obtained through SDATAIN pins of a serial general purpose input/output (SGPIO) port.

In step 130, a predetermined-hard-disk-identification number of the predetermined hard disk is created according to the group identification number and a slot number of the predetermined slot. For example, at most four hard disks can be simultaneously plugged in a typical back plate, so that the predetermined-hard-disk-identification number can be calculated by the following equation:

predetermined-hard-disk-identification number=(4*group identification number)+slot number (1)

When the group identification number of the predetermined hard disk (i.e. the back plate identification number of the predetermined back plate) is equal to one, and the predetermined hard disk; is plugged in the third slot of the predetermined back plate, the predetermined identification number of the predetermined hard disk can be set as seven [obtained from the equation (4*1)+3]. However, in other embodiments, the number “4” may be replaced by the other numbers according to the maximum number of the hard disks that can be simultaneously connected to the back plate. Therefore, the predetermined-hard-disk-identification number of the predetermined hard disk can be obtained through the predetermined port by the steps 120 and 130.

Then, in step 140, the predetermined port and the predetermined-hard-disk-identification number obtained through the predetermined port are stored in a port mapping table. Thus, the port mapping table can be established in the startup process by the steps 110 through 140.

Next, when an access instruction for accessing a target hard disk is received (step 150), a target slot of a target back plate, which the target hard disk is plugged in, is obtained (step 160) according to a target-hard-disk-identification number of the target hard disk. For example, when the equation (1) is applied to create the predetermined-hard-disk-identification number, the target back plate, which the target hard disk is plugged in, is the quotient of the division of the target-hard-disk-identification number by four, and the target slot, which the target hard disk is plugged in, is the remainder of the division of the target-hard-disk-identification number by four. Thus, if the target-hard-disk-identification number of the target hard disk requested by the access instruction is “7”, the following equation can be used.

7÷4=1 remainder 3 (2)

From the equation (2), it is known that the target hard disk is plugged in the third slot (the remainder of the equation (2)) of the target back plate and the group identification number of the target back; plate is “1” (the quotient of the equation (2)).

In addition, the port mapping table is inquired according to the target-hard-disk-identification number of the target hard disk (step 170), to obtain a target port which the target back plate is connected with (step 180). Then, in step 190, the target hard disk plugged in the target slot of the target back plate is accessed through the target port.

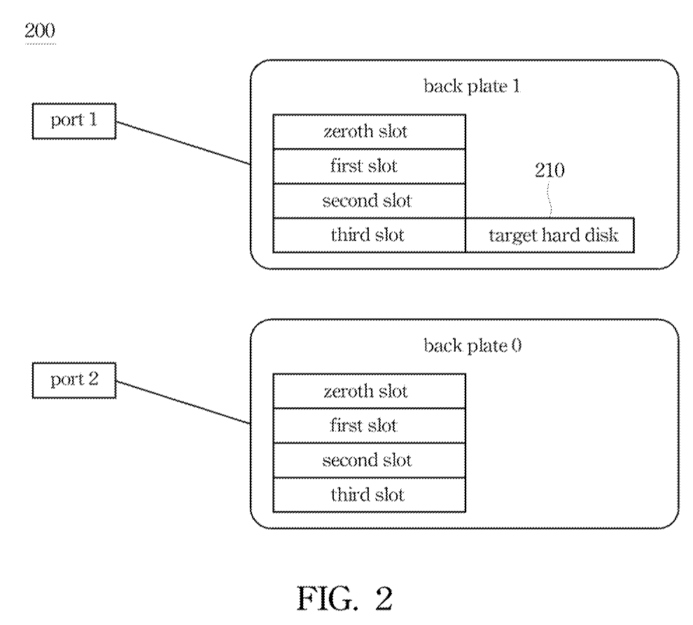

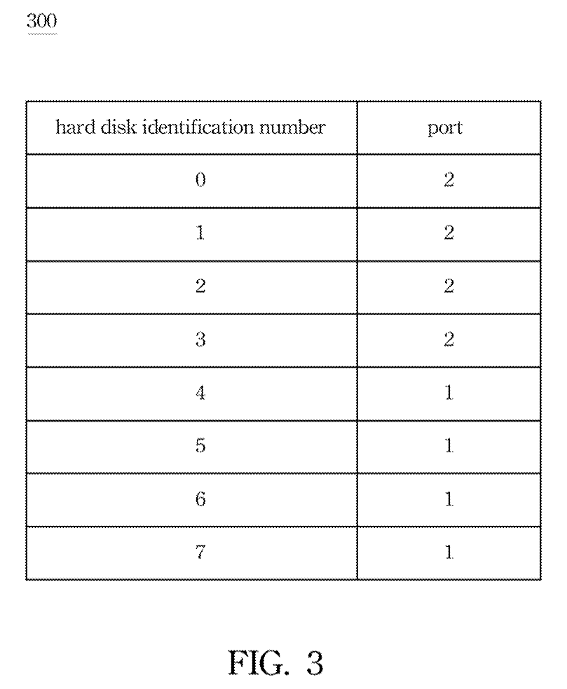

FIG. 2 is a schematic diagram showing a hard disk expansion system 200 using a hard disk access method 100. FIG. 3 illustrates a port mapping table 300 of the hard disk expansion system 200 in FIG. 2. Simultaneously refer to FIGS. 2 and 3. If a target-hard-disk-identification number of a target hard disk 210 requested by an access instruction is “7”, it can be obtained that a back plate 1, which the target hard disk 210 is plugged in, is connected with a port 1 by inquiring the port mapping table 300. Thus, the target hard disk 210 plugged in the third slot of the back plate 1 is accessed through the port 1.

According to the aforementioned embodiments of the present invention, the present invention includes the following advantages. With the application of the present invention, the port connected with the hard disk can be obtained through the port mapping table established in each startup process. Therefore, when the back plate, which the hard disk is plugged in, is connected to the different port, the hard disk can be directly accessed according to the port mapping table established in the startup process without setting anew.

As is understood by a person skilled in the art, the foregoing embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A hard disk access method, including:
establishing a port mapping table in the execution of a startup process;
receiving an access instruction for accessing a target hard disk;
obtaining a target slot of a target back plate, which the target hard disk is plugged in, according to a target-hard-disk-identification number of the target hard disk;
inquiring the port mapping table to obtain a target port, which the target back plate is connected with, according to the target-hard-disk-identification number of the target hard disk; and
accessing the target hard disk plugged in the target slot of the target back plate through the target port.

2. The hard disk access method according to claim 1, wherein the step of establishing the port mapping table includes:
obtaining at least one predetermined-hard-disk-identification number of at least one predetermined hard disk through at least one predetermined port; and
storing the at least one predetermined port and the at least one predetermined-hard-disk-identification number obtained through the at least one predetermined port in the port mapping table.

3. The hard disk access method according to claim 2, wherein the step of obtaining the at least one predetermined-hard-disk-identification number of the at least one predetermined hard disk through the at least one predetermined port includes:
obtaining at least one group identification number of the at least one predetermined hard disk through the at least one predetermined port, wherein the at least one predetermined hard disk is plugged in at least one predetermined slot of at least one predetermined back plate, and the at least one group identification number is at least one back plate identification number of the at least one predetermined back plate; and
creating the at least one predetermined-hard-disk-identification number of the predetermined hard disk according to the at least one group identification number and at least one slot number of the at least one predetermined slot.

4. The hard disk access method according to claim 3, wherein the step of obtaining the at least one group identification number is through SDATAIN pins of a serial general purpose input/output (SGPIO) port.
